(19) United States
(12) Patent Application Publication
(10) Pub. No.: US 2015/0021004 A1
(43) Pub. Date: Jan. 22, 2015

(54) EGR Cooler

(71) Applicant: International Engine Intellectual Property Company LLC, Lisle, IL (US)

(72) Inventors: Gary K. Mui, Arlington Heights, IL (US); Andrew K. Stobnicki, Deerfield, IL (US); Timothy Pyles, Chicago, IL (US)

(21) Appl. No.: 13/945,360

(22) Filed: Jul. 18, 2013

(51) Int. Cl. F28D 21/00; F02M 25/07

(52) U.S. Cl. CPC F28D 21/0003; F02M 25/0737
USPC 165/158

(57) ABSTRACT

An EGR cooler has supports supporting coolant core tubes on the top, the bottom, and the side walls of a cooler housing. Each support has a base plate on at least one tube and an overlying spring plate which bears against the respective wall on the interior of the cooler housing. The supports for supporting at least one tube on the top and bottom walls are at the same first location along the lengths of the tubes, and the supports for supporting the tubes on the side walls are at the same second location along the lengths of the tubes. The second location is between the first location and an outlet header plate at exit ends of the tubes and the tubes are free of support on the top wall, the bottom wall and the side walls between the first location and an inlet header plate.

### TECHNICAL FIELD

This disclosure relates generally to internal combustion engines, especially diesel engines in motor vehicles which use exhaust gas recirculation (EGR) as a component of tailpipe emission control strategy. The disclosure particularly relates to an EGR cooler for cooling exhaust gas being recirculated.

### BACKGROUND

A typical EGR system of an engine includes one or more EGR valves for controlling the flow of engine exhaust gas from the engine's exhaust system to the engine's intake system to meter a controlled quantity of exhaust gas into fresh air passing through the intake system where the air supports combustion of fuel in the engine's cylinders. The metered exhaust gas can limit in-cylinder temperature rise during combustion and consequently limit the quantity of oxides of nitrogen (NOx) in engine-out exhaust gas.

Some EGR systems, especially those designed for compression ignition (i.e. diesel) engines, have one or more heat exchangers for cooling recirculated exhaust gas. They are sometimes referred to as EGR coolers. Cooling of exhaust gas being recirculated can further limit the quantity of NOx in engine-out exhaust gas.

### SUMMARY OF THE DISCLOSURE

An EGR cooler currently used in a production engine has top, bottom and side spring plates which support tubes in the cooler core on interior surfaces of top, bottom and side walls of a cooler housing. The top and bottom spring plates are at the same location along the lengths of the tubes. The side spring plates are at the same location along the lengths of the tubes, but their location along the lengths of the tubes is between that of the top and bottom spring plates and an end of the cooler housing through which the cooler core is inserted into the cooler housing.

An EGR cooler like other engine components is subject to thermal and mechanical stresses.

It has been discovered that stress levels in certain components of the core can be significantly reduced, thereby potentially extending the cooler's useful life, by relocating the side spring plates along the lengths of the tubes to a location which is between the location of the top and bottom spring plates and an end of the cooler housing opposite the end through which the core is inserted into the cooler housing.

The disclosed EGR cooler has a cooler housing which has a top wall, a bottom wall, and side walls bounding an interior having a rectangular cross section along a length of the cooler housing. The cooler housing has a coolant inlet through which engine coolant enters the interior and a coolant outlet through which coolant exits the interior.

A coolant core comprises lengthwise extending straight, flat-walled tubes for conveying exhaust gas through the coolant core. The tubes are arranged side-by-side with their flat walls separated from flat walls of adjacent tubes by intervening spaces. The tubes collectively have a rectangular cross section smaller than the rectangular cross section of the interior along the lengths of the tubes.

An inlet header plate comprises side-by-side through-slots, with each of which an entrance end of each tube registers. Each tube is joined to the inlet header plate to secure and seal the tube wall entrance end around the outside of the tube wall to the inlet header plate.

An outlet header plate comprises side-by-side through-slots, with each of which an exit end of each tube registers. Each tube is joined to the outlet header plate to secure and seal the tube wall exit end around the outside of the tube wall to the outlet header plate.

The inlet header plate and the outlet header plate are captured with respect to the cooler housing.

Supports support at least one of the tubes on the top, the bottom, and the side walls of the cooler housing. Each support comprises a base plate on at least one of the tubes and a spring plate on the respective base plate which bears against the respective wall on the interior of the cooler housing.

The supports for supporting the tubes on the top and bottom walls are at the same first location along the lengths of the tubes, and the supports for supporting the tubes on the side walls are at the same second location along the lengths of the tubes. The second location is between the first location and the outlet header plate. The tubes are free of support on the top wall, the bottom wall and the side walls between the first location and the inlet header plate.

The foregoing summary is accompanied by further detail of the disclosure presented in the Detailed Description below with reference to the following drawings which are part of the disclosure.

### BRIEF DESCRIPTION OF THE DRAWINGS

FIG. 1 is a perspective view of an EGR valve and cooler assembly.

FIG. 2 is an exploded view showing a core of the cooler of FIG. 1.

FIG. 3 is a perspective view of the cooler core with a portion omitted for illustrative purposes.

FIG. 4 is an enlarged fragmentary cross section view in the direction of arrows 4-4 in FIG. 3.

FIG. 5 is a fragmentary view of the near portion of FIG. 3 from a different perspective to show additional parts.

FIG. 6 is an enlarged view in the direction of arrow 6 in FIG. 1.

FIG. 7 is an enlarged view in oval 7 in FIG. 2.

FIG. 8 is an enlarged view in oval 8 in FIG. 2.

FIG. 9 is an enlarged view in oval 9 in FIG. 8.

FIG. 10 is view in the direction of arrow 10 in FIG. 9.

FIG. 11 is an enlarge perspective view of a portion of FIG. 2 looking from the rear.

### DETAILED DESCRIPTION

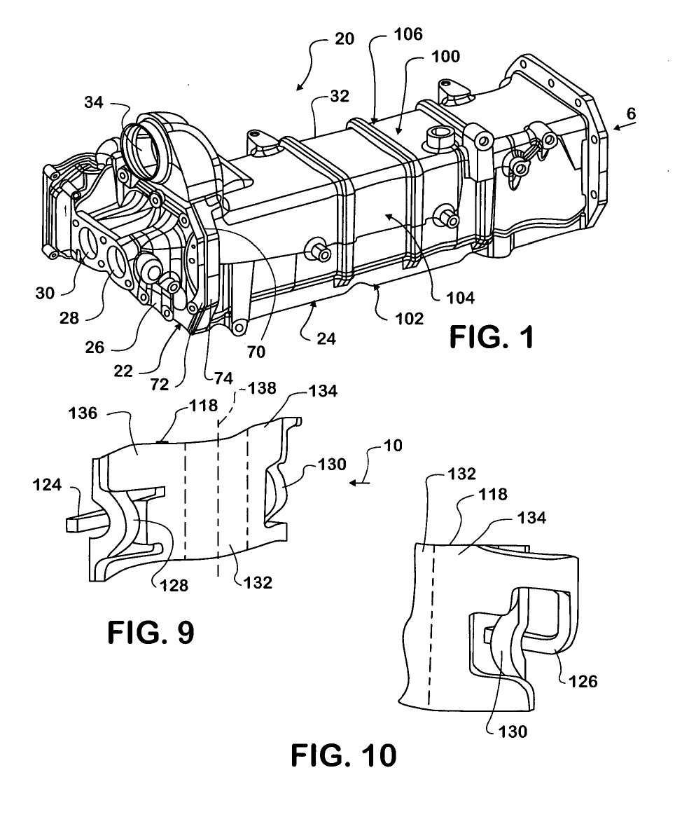

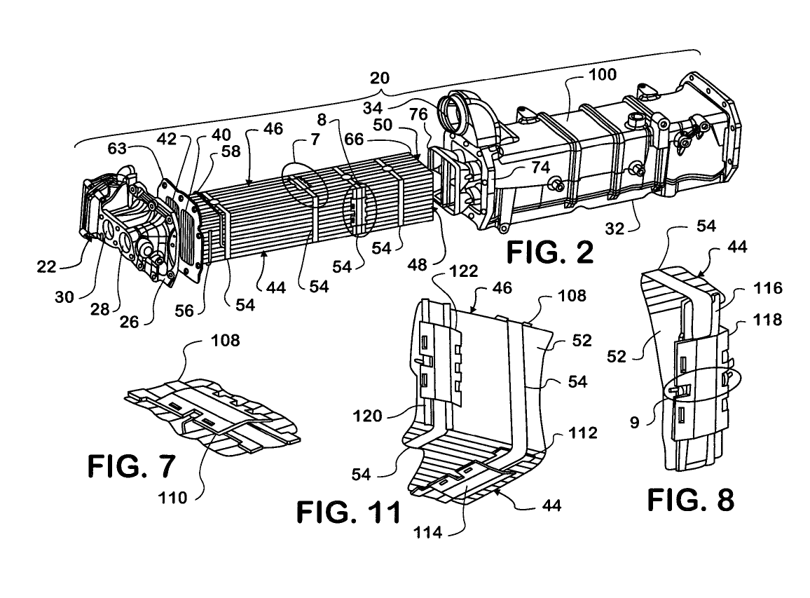

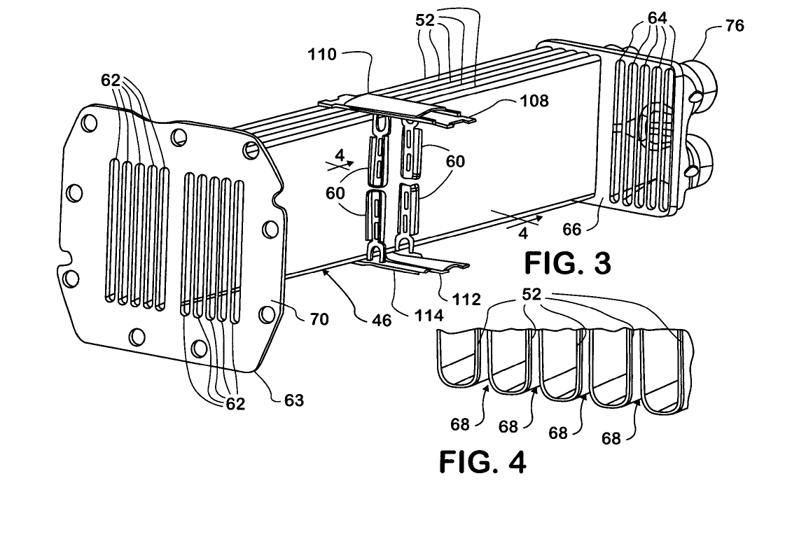

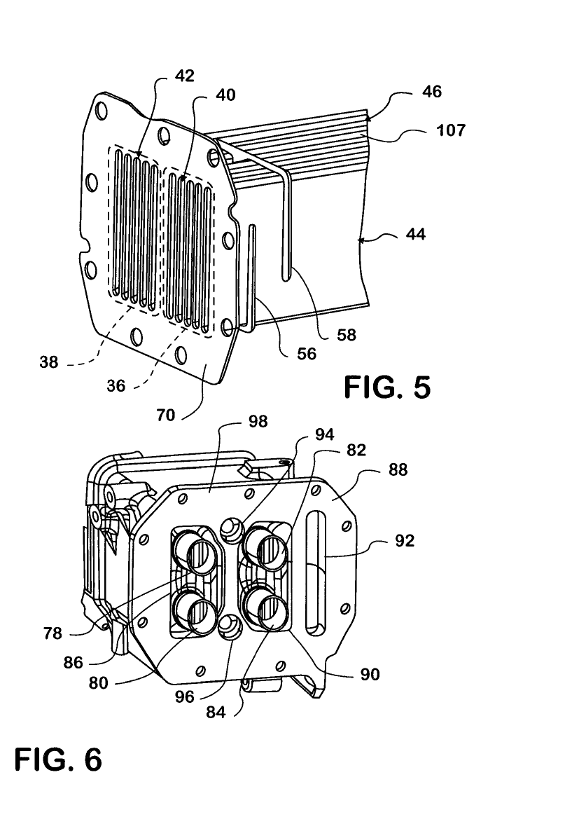

FIGS. 1 and 2 show an EGR valve and cooler assembly 20 comprising an EGR valve 22 and an EGR cooler 24. EGR valve 22 comprises a valve housing 26 having a pair of inlets 28, 30 through which engine exhaust gas being recirculated enters assembly 20. EGR cooler 24 comprises a cooler housing 32 having a coolant inlet 34 through which engine coolant enters. Valve housing 26 has a pair of outlets 36, 38 shown in phantom in FIG. 5. Each outlet 36, 38 is open to an inlet 40, 42 of a respective set of tubes 44, 46. The tube sets 44, 46 have respective outlets 48, 50 shown in FIG. 2. The individual tubes 52 are elements of a lengthwise extending core of EGR cooler 24.

Each tube set 44, 46 comprises, by way of example, five straight, flat-walled tubes 52 arranged side-by-side. The tubes 52 in each set may be banded together by bands 54 to convert each tube set into a banded tube bundle. Each tube set 44, 46 has a generally rectangular-shape comprising a top, a bottom, and two sides. Tube sets 44, 46 may be kept separated from each other by separator elements 56, 58 (FIGS. 2 and 5) which are fit onto the tube sets from top and bottom respectively at locations between inlets 40, 42 and the band 54 nearest inlets 40, 42. Tube sets 44, 46 are also kept separated from each other by separator elements 60 (FIG. 3) on either side of the next band 54 along the length of the cooler core.

Tubes 52 are identical with each having flat parallel sides joined by rounded ends at top and bottom. At inlets 40, 42, the entrance to each tube 52 in each tube set 44, 46 registers with a respective slot 62 extending through an inlet header plate 63. At outlets 48, 50, the exit from each tube 52 in each tube set 44, 46 registers with a respective slot 64 (FIG. 3) extending through an outlet header plate 66. At the registration of each tube and slot, the respective tube 52 is joined to the respective header plate to secure and seal the tube wall end around the outside of the tube wall to the header plate. Because respective slots 62 and respective slots 64 are separated from each other in their respective header plate, this joining of tubes 52 to the header plates keeps the side-by-side tubes 52 separated from adjacent tubes 52 by intervening spaces 68 (FIG. 4) between the tubes' flat walls.

Inlet header plate 63 has a surrounding flange 70 which is held sandwiched between a surrounding flange 72 of valve housing 26 and a surrounding flange 74 at an end of cooler housing 32 by fasteners (not shown) passing through registered holes in the respective flanges. Each respective valve outlet 36, 38 is open to the entrances of the five tubes 52 in the respective tube set 44, 46.

An end cap 76 fits over and is joined to outlet header plate 66. End cap 76 comprises outlets 78, 80 (FIG. 6) which are open to the exit ends of tubes 52 in tube set 44 and outlets 82, 84 which are open to the exit ends of tube 52 in tube set 46. Outlets 78, 80 pass with clearance through a through-passage 86 in an end wall 88 of cooler housing 32, and outlets 82, 84 pass with clearance through a through-passage 90 in end wall 88. End wall 88 further comprises a narrower through-slot 92 to one side of through-passage 90, two through-holes 94, 96 between through-passages 86, 90, and a surrounding flange 98. Flange 98 attaches the exit end of cooler housing 32 to a mating part (not shown) for conveying exhaust gas and coolant which have passed through EGR cooler 24 to the engine intake system and the engine coolant system respectively.

Along the lengths of tube sets 44, 46, the interior of coolant housing 32 has a uniform rectangular cross section bounded by interior surfaces of a top wall 100 of cooler housing 32, a bottom wall 102 of cooler housing 32, and side walls 104, 106 of cooler housing 32. Exhaust gas which has entered EGR cooler 24 from EGR valve 22 flows through tubes 52 to exit EGR cooler 24 through outlets 78, 80, 82, 84. Engine coolant which has entered EGR cooler 24 from the engine coolant system through coolant inlet 34 flows concurrently along parallel flow paths comprising spaces 68, a space 107 (FIG. 5) between tube sets 44, 46, a space between tube sets 44, 46 and top wall 100, a space between tube sets 44, 46 and bottom wall 102, a space between tube set 44 and side wall 104, and a space between tube set 46 and side wall 106, all leading toward end wall 88. Coolant finally flows from these paths through clearance between the perimeter of end cap 76 and coolant housing 32 to exit EGR cooler 24 through a coolant outlet in end wall 88 formed by through-passage 86, through-passage 90, through-slot 92 and through-holes 94, 96. Exhaust gas and liquid coolant flow through EGR cooler 24 in parallel directions without mixing but in heat transfer relation through the thermally conductive walls of tubes 52.

Collectively, tube sets 44, 46 have a rectangular cross section smaller than that of the interior of cooler housing 32. In addition to support for the tube sets provided by the attachment of their tubes 52 to header plates 63, 66 as already described, tube sets 44, 46 are supported at locations along their length on walls 100, 102, 104, and 106. Each support comprises a base plate on at least some of the tubes and a spring plate on the base plate which bears against the interior surface of a respective wall 100, 102, 104, 106.

Support on top wall 100 is provided by a top base plate 108 which transversely bridges the tops of the two tube sets 44, 46 and a top spring plate 110 which fits onto base plate 108. Support on bottom wall 102 is provided by a bottom base plate 112 (FIG. 11) which transversely bridges the bottoms of the two tube sets and a bottom spring plate 114 which fits onto bottom base plate 112. These top and bottom supports for the cooler core are at the same location along the lengths of tubes 52. Separator elements 60 are attached to top base plate 108 and bottom base plate 112 as shown in FIG. 3.

Support on side wall 104 is provided by a side base plate 116 (FIG. 8) affixed to the outer surface of the outer tube 52 of tube set 44 facing the interior surface of side wall 104 and a side spring plate 118 which fits onto base plate 116. Support on side wall 106 is provided by a side base plate 120 (FIG. 11) affixed to the outer surface of the outer tube 52 of tube set 46 facing the interior surface of side wall 106 and a side spring plate 122 which fits onto side base plate 120. These two side supports are at the same location along the lengths of tubes 52 a location which is between the location of the core's top and bottom supports 108, 110; 112, 114 along the lengths of the tubes and outlet header plate 66.

Each spring plate has attaching features, such as those referenced by numerals 124, 126 in FIGS. 9 and 10, providing for it to attach to the respective base plate by engagement with respective features 128, 130 of the latter. When attached to the respective base plate, the respective spring plate is disposed over the base plate.

Each spring plate has a generally rectangular expanse comprising a length, which is transverse to the lengths of tubes 52, and a width, which is parallel to the lengths of the tubes. A spring plate may be considered to have a central zone 132 which is bowed outwardly from side zones 134, 136 at opposite sides of central zone 132 which bear against the underlying base plate. Stated another way, the outer surface of each spring plate which faces away from the underlying base plate presents a convex contour which at an apex 138 (FIG. 9) running along the length of the spring plate at the middle of central zone 132 is more distant from the base plate than portions of the outer surface to either side of the apex.

Prior to assembly of the core into cooler housing 32, the distance from the apex 138 of one spring plate to the apex 138 of the spring plate on the opposite side of tube sets 44, 46 is greater than the distance between the interior surfaces of the cooler walls which will support the tube sets through those spring plates and underlying base plates when the core is assembled into the cooler housing.

Assembly of the core into cooler housing 32 is performed by inserting end cap 76 into the open end of the cooler housing which is surrounded by flange 74 and advancing the core inwardly. The rectangular perimeter of end cap 76 has clearance to the interior of cooler housing 32. At some point of insertion, the bowed outer faces of side spring plates 118, 122 will attain essentially concurrent contact with the edges of the cooler housing side walls 104, 106 at flange 74. Continued forceful insertion of the core will cause those side spring plates to ride along those edges, flexing the side spring plates increasingly inward. Maximum flexing occurs when core insertion reaches the point at which the apex 138 of each side spring plate comes into contact with the interior wall surface.

Continued insertion will eventually cause top and bottom spring plates 110. 114 to flex in the same manner, and thereafter the four flexed spring plates to ride along the respective interior surfaces until an outer margin of end cap 76 abuts an outer margin of end wall 88 and flange 72 concurrently sandwiches header plate flange 70 against flange 74, capturing the inlet header plate and the outlet header plate with respect to the cooler housing. Flanges 70, 72, 74 can then be fastened together.

The supports on the top and bottom walls (spring plates 110, 114) are at the same first location along the lengths of tubes 52 and the supports on the side walls (spring plates 118, 122) are at the same second location along the lengths of tubes 52. The second location is between the first location and outlet header plate 66. Tubes 52 are free of support on top wall 100, bottom wall 102, and side walls 104, 106 between the first location and inlet header plate 63.

The various components which have been described are fabricated from suitable materials for their intended uses in EGR cooler 24.

What is claimed is:

1. An EGR cooler comprising:
a cooler housing which has a top wall, a bottom wall, and sides walls bounding an interior having a rectangular cross section along a length of the cooler housing;
a coolant inlet through which engine coolant enters the interior and a coolant outlet through which coolant exits the interior;
a coolant core comprising lengthwise extending straight, flat-walled tubes for conveying exhaust gas through the coolant core, the tubes being arranged side-by-side with their flat walls separated from flat walls of adjacent tubes by intervening spaces;
the tubes collectively having a rectangular cross section smaller than the rectangular cross section of the interior along the lengths of the tubes;
an inlet header plate comprising side-by-side through-slots, with each of which an entrance end of each tube registers, each tube being joined to the inlet header plate to secure and seal the tube wall entrance end around the outside of the tube wall to the inlet header plate;
an outlet header plate comprising side-by-side through-slots, with each of which an exit end of each tube registers, each tube being joined to the outlet header plate to secure and seal the tube wall exit end around the outside of the tube wall to the outlet header plate;
the inlet header plate and the outlet header plate being captured with respect to the cooler housing; and
supports for supporting at least one of the tubes on each of the top, the bottom, and the side walls of the cooler housing, each support comprising a base plate on at least one of the tubes and a spring plate on the respective base plate which bears against the respective wall on the interior of the cooler housing, the supports for supporting at least one of the tubes on the top and the bottom walls being at the same first location along the lengths of the tubes, the supports for supporting at least one of the tubes on the side walls being at the same second location along the lengths of the tubes, the second location being between the first location and the outlet header plate, and the tubes being free of support on the top wall, the bottom wall and the side walls between the first location and the inlet header plate.

2. The EGR cooler as set forth in claim 1 in which the coolant core comprises two side-by-side tube sets, the base plates in the supports for supporting at least one tube on the top and the bottom walls being disposed on the two side-by-side tube sets.

3. The EGR cooler as set forth in claim 2 in which the base plates in the supports for supporting at least one tube on the side walls are disposed on an outer surface of a flat wall of an outer tube in the respective tube set facing a respective side wall.

4. The EGR cooler as set forth in claim 2 including bands which band the tubes in each tube set into a respective tube bundle.

5. The EGR cooler as set forth in claim 2 including at least one separator element disposed between the tube bundles for keeping each tube bundle separated from the other.

6. The EGR cooler as set forth in claim 1 in which the base plates in the supports for supporting at least one tube on the top and the bottom walls are disposed on all of the tubes.

7. The EGR cooler as set forth in claim 6 in which the base plates in the supports for supporting at least one tube on the side walls are disposed on an outer surface of a flat wall of an outer tube facing a respective side wall.
